(19) United States
(12) Patent Application Publication
(10) Pub. No.: US 2016/0215691 A1
(43) Pub. Date: Jul. 28, 2016

(54) ENGINE

(71) Applicant: KAWASAKI JUKOGYO KABUSHIKI KAISHA, Kobe-shi (JP)

(72) Inventors: Hiroyuki Watanabe, Kobe-shi (JP); Hisatoyo Arima, Himeji-shi (JP); Satoaki Ichi, Akashi-shi (JP); Yoshiharu Matsuda, Akashi-shi (JP); Shohei Naruoka, Kakogawa-shi (JP)

(21) Appl. No.: 15/087,756

(22) Filed: Mar. 31, 2016

Related U.S. Application Data
(63) Continuation of application No. PCT/JP2013/081038, filed on Nov. 18, 2013.

(51) Int. Cl. F02B 77/08; F02D 35/02; F02B 75/20; F02B 61/02

(52) U.S. Cl. CPC F02B 77/085; F02B 61/02; F02D 35/027; F02B 75/20

(57) ABSTRACT

An upwardly protruding cylinder block is formed in a front portion of a crankcase for supporting a crankshaft of an engine. A cylinder head is connected with an upper portion of the cylinder block, and a combustion chamber of an internal combustion engine is formed within the cylinder block and the cylinder head. A knocking sensor for detecting the occurrence of knocking in the engine is fitted to a left side end surface of the cylinder block.

### CROSS REFERENCE TO THE RELATED APPLICATION

This application is a continuation application, under 35 U.S.C §111(a) of international application No. PCT/JP2013/081038, filed Nov. 18, 2013.

### BACKGROUND OF THE INVENTION

1. (Field of the Invention)

The present invention relates to an engine having a knock sensor fitted thereto for detecting the occurrence of an engine knocking.

2. (Description of Related Art)

In a combustion engine mounted on, for example, a motorcycle, the use of a knock sensor thereon for detecting the occurrence of an engine knocking has been known. For example, reference may be made to Patent Document 1 listed below. According to the combustion engine disclosed in the Patent Document 1 referred to above, the knock sensor is fitted to a rear surface of a cylinder head.

### PRIOR ART LITERATURE

Patent Document 1: JP Laid-open Patent Publication No. 2008-297967

It has, however, been found that engine peripheral components such as a starter motor and a throttle body are quite often disposed rearwardly of the cylinder head and, therefore, positioning of the knock sensor on a rear surface of the cylinder head such as suggested in the Patent Document 1 referred to above makes it difficult to avoid interference between some or all of the engine peripheral components and the knock sensor.

### SUMMARY OF THE INVENTION

In view of the foregoing, the present invention has been devised to substantially eliminate the problems and inconveniences discussed above and is intended to provide an engine in which interference between the engine peripheral components and the knock sensor is avoided to permit a space around the engine to be efficiently utilized.

In order to accomplish the foregoing object, the present invention provides an engine including a cylinder structural body for defining a combustion chamber of an internal combustion engine and a knock sensor for detecting the occurrence of a knocking in the engine, in which case the knock sensor is fitted to a side end surface of the cylinder structural body in a rotational axial direction of a rotary shaft of the engine. In the case of the engine of a type mounted on the motorcycle, the rotational axial direction of the rotary shaft referred to above is a vehicle widthwise direction (leftward and rightward direction) and, accordingly, in the practice of the present invention the nock sensor is fitted to that side end face of the cylinder structural body that lies in the vehicle widthwise direction.

According to the above described construction, the nock sensor is fitted to the side end surface of the cylinder structural body, which surface lies in the direction of a rotary shaft of the engine. Accordingly, even when peripheral components are disposed adjacent to a side that lie perpendicular to a rotary shaft of the engine, without the knock sensor interfering with the components, a space adjacent the engine can be efficiently utilized and, also, the assemblability and maintenance of the nock sensor are improved. The peripheral components referred to above is at least one of, for example, a throttle valve, a cooling water intake opening, a balancer, a stator motor, a supercharger and a breather chamber.

In one preferred embodiment of the present invention, the knock sensor referred to above is preferably disposed in one end of the cylinder structural body in a direction perpendicular to both of the rotational direction of the rotary shaft and a direction of a bore axial line. According to this structural feature, through a wall extending in the rotational axial direction of the rotary shaft and a wall extending in the direction perpendicular to the bore axial line of a wall of the cylinder structural body, vibrations taking place in a cylinder can be detected.

Where the knock sensor is disposed in the end portion in the orthogonal direction, the knock sensor is preferably disposed on an outer side of the orthogonal direction opposite to a cooling passage (water jacket) formed in an interior of a wall of the cylinder structural body. According to this structural feature, vibrations from the cylinder is transmitted directly to the knock sensor bypassing the cooling passage and, therefore, the occurrence of the knocking can be precisely detected.

In one preferred embodiment of the present invention, the knock sensor is preferably disposed at a portion proximate to an outer surface, of the cylinder structural body, where an air intake port is disposed. According to this structural feature, since the air intake side is lower in temperature than the exhaust side, the temperature rise of the knock sensor can be suppressed.

In another preferred embodiment of the present invention, the knock sensor is preferably disposed in a side end surface of the cylinder structural body that is on an opposite side of a power transmission mechanism configured to transmit a rotational force of the engine to a camshaft. The power transmission mechanism referred to above includes, for example, a chain, a belt or a shaft. According to this structural feature, without the knock sensor interfering with the power transmission mechanism, a space around the engine can be further efficiently utilized.

Where the knock sensor is disposed in the end portion in the orthogonal direction, the cylinder structural body may be formed with a mounting hole that extends in the bore axial line direction, and the knock sensor may be disposed on the outer side of the orthogonal direction opposite to the hole referred to above. The mounting hole referred to above is in the form of, for example, a hole through which a bolt for connecting the cylinder head with the cylinder block is inserted. According to this structural feature, vibrations from the cylinder are transmitted directly to the knock sensor bypassing the mounting hole and, therefore, the occurrence of knocking can be precisely detected.

In a further preferred embodiment of the present invention, the knock sensor is preferably disposed on an inner side of the rotational axial direction opposite to an outer side end edge of a covering mounted on one side portion of the engine. The covering mounted on that one side portion of the engine The covering mounted on the one side portion of the engine is in the form of, for example, a generator covering. According to this structural feature, since the knock sensor is disposed inwardly of the covering, the knock sensor is protected by the covering even when the engine is overturned.

In a still further preferred embodiment of the present invention, the engine is in the form of a multi-cylinder engine, and the knock sensor is preferably disposed in the vicinity of one of cylinders that is apt to be knocked. The cylinder apt to be knocked is, for example, a cylinder that is ignited earlier than neighboring cylinders. In the case of the four cylinder engine, in which first to four cylinders are fired in the sequence of the first cylinder, subsequently followed by the second cylinder, then followed by the fourth cylinder and finally followed by the third cylinder, the first cylinder is ignited earlier than the next neighboring second cylinder, and the fourth cylinder is ignited earlier than neighboring third cylinder. On the other hand, the second cylinder is ignited after the ignition of the neighboring first cylinder and the third cylinder is ignited after the ignition of the neighboring fourth cylinder. The cylinder that is ignited earlier than the neighboring cylinder, that is the first or fourth cylinder in this case, can guide the intake air in a quantity larger than that in the cylinder which is ignited after the ignition of the neighboring cylinder, and, therefore, a high output can result in. Positioning of the knock sensor in the vicinity of the cylinder that results in the high output as mentioned above is effective to allow the occurrence of knocking to be efficiently detected.

In a yet further preferred embodiment of the present invention, where the crankcase is formed with the transmission casing, the knock sensor may be disposed in a portion of a side end surface of the cylinder structural body, which portion is close to the transmission casing side. In this case, a supercharger configured to compress an air and then supply the air to the engine can be disposed above the transmission casing. Accordingly, the space around the engine can be further efficiently utilized.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a schematic side view showing a motorcycle equipped with a combustion engine according to a preferred embodiment of the present invention;

FIG. 2 is a perspective view showing the combustion engine as viewed from above and diagonally rearwardly;

FIG. 3 is a perspective view showing the combustion engine as viewed along a cylinder bore axial line; and

FIG. 4 is a schematic sectional view showing a mounting structure of a knock sensor in the combustion engine.

### DESCRIPTION OF PREFERRED EMBODIMENTS

Hereinafter a preferred embodiment of the present invention will be described in detail with particular reference to the accompanying drawings. In describing the present invention, however, the terms “left and right” used hereinabove and hereinafter are to be understood as relative terms description of positions and/or direction as viewed from a driver maneuvering a vehicle.

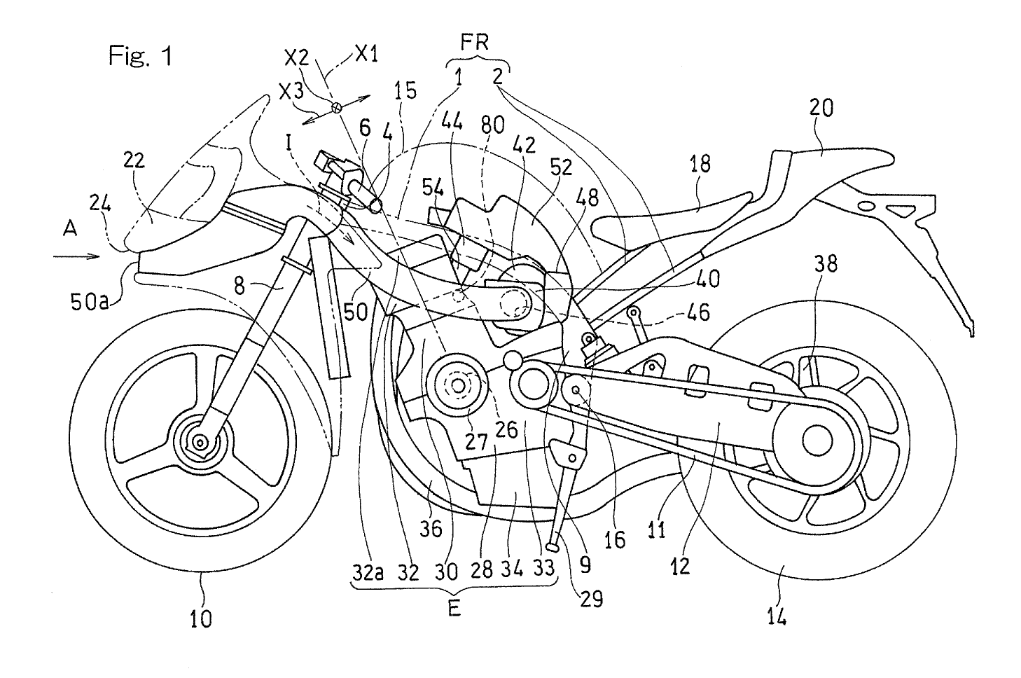

FIG. 1 illustrates a schematic side view of a motorcycle equipped with an engine having a knock sensor according to a preferred embodiment of the present invention. The illustrated motorcycle includes a motorcycle frame structure FR made up of a main frame 1, which forms a front half portion of such frame structure FR, and a seat rail 2 which forms a rear half portion of such frame structure FR. The seat rail 2 is fitted to a rear portion of the main frame 1. The main frame 1 has its front end provided with a head pipe 4, and a front fork 8 is rotatably supported by the head pipe 4 through a steering shaft (not shown). The front fork 8 has a lower end portion to which a front wheel 10 is fitted, and a steering handlebar 6 is fixed to an upper end portion of the front fork 8.

On the other hand, a swingarm bracket 9 is provided at a rear end portion of the main frame 1, which is a lower intermediate portion of the motorcycle frame structure FR. A swingarm 12 is supported by a pivot pin 16, fitted to the swingarm bracket 9, for movement up and down about such pivot pin 16. This swingarm 12 has a rear end portion by which a rear wheel 14 is rotatably supported. A combustion engine E, which is a drive source of the motorcycle, is fitted to a lower intermediate portion of the motorcycle frame structure FR and on a front side of the swingarm bracket 9. This combustion engine E drives the rear wheel 14 through a power transmission mechanism 11 such as, for example, a substantially endless chain. The combustion engine E referred to above is in the form of, for example, a water-cooled four cylinder, four cycle parallel multi-cylinder engine, but in the practice of the present invention, the combustion engine may not be necessarily limited to that specific type described above and may be of a type having one to three cylinders or five or more cylinders.

The combustion engine E includes a crankshaft 26 having a rotary shaft extending in a leftward and rightward direction (vehicle widthwise direction), a crankcase 28 supporting the crankshaft 26, a cylinder block 30 protruding upwardly from a front upper surface of the crankcase 28, a cylinder head 32 above the cylinder block 30, a cylinder head covering 32a for covering an upper portion of the cylinder head 32 and an oil pan 34 provided below the crankcase 28. The crankcase 28 has a rear portion concurrently serving as a transmission casing 33 for accommodating a transmission. It is to be noted that the crankcase 28 and the mission case 33 may be separate from each other. The crankshaft 26 has a left end portion provided with an electric generator (not shown), and the crankcase 28 has a left side surface to which a generator covering 27 is fitted for covering the electric generator from laterally outwards.

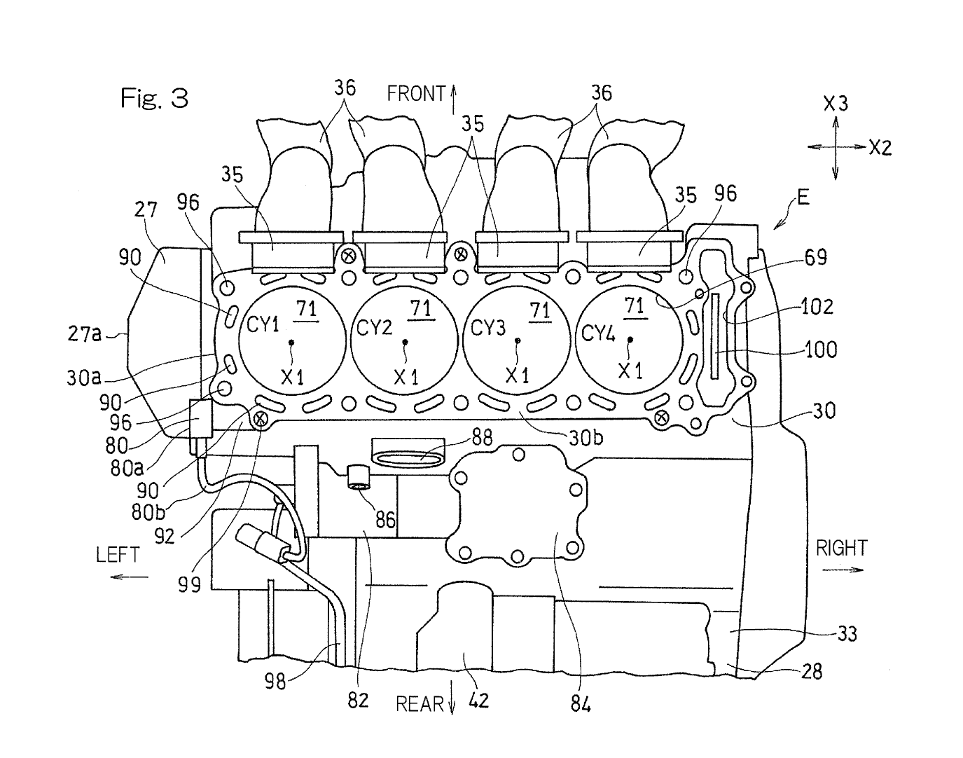

In the combustion engine employed in the practice of the embodiment now under discussion, the cylinder block 30 and the cylinder head 32 are somewhat tilted forwards. In other words, the cylinder has a bore axial line X1 extending diagonally upwards and forwardly. The cylinder block 30 and the cylinder hear 32 cooperate with each other to form a cylinder structural body for forming a combustion chamber 71 (shown in FIG. 3) of an internal combustion engine.

Four exhaust pipes 36 are connected respectively with four exhaust ports 35 (shown in FIG. 3) defined on a front surface of the cylinder head 32. Those four exhaust pipes 36 are merged together at a site beneath the combustion engine E and are then connected with an exhaust muffler 38 disposed on a right side of the rear wheel 14.

A fuel tank 15 is disposed on an upper portion of the main frame 1, and a driver's seat 18 and a fellow passenger's seat 20 are supported on the seat rail 2. Also, a cowing or fairing 22 made of a resinous material is mounted on a vehicle front portion. The fairing 22 covers an area ranging from forwardly of the head pipe 4 to opposite lateral area of the vehicle front portion. The fairing 22 is formed with an air intake opening 24 defined therein. The air intake opening 24 is positioned at a front end of the fairing 22 and introduces an intake air therethrough to the combustion engine E from the outside.

On a left side of the motorcycle frame structure FR, an air intake duct 50 is disposed. This air intake duct 50 is supported by the head pipe 4 with its front end opening 50a aligned with the air intake opening 24. Air introduced from the front end opening 50a of the air intake duct 50 is increased in pressure by the known ram effect.

At a position rearwardly of the cylinder block 30 and on an upper surface of the crankcase 28, that is, above the transmission casing 33, an air cleaner 40 for substantially purifying the air and a supercharger 42 are disposed in juxtaposed relation to each other. The air intake duct 50 extends from the front of the engine E lateral outer side of the cylinder block 30 and the cylinder head 32 so as to guide an incoming air A to the air cleaner 40 as an intake air I. The supercharger 42 pressurizes and supplies a purified air from the air cleaner 40 to the combustion engine E.

Between a discharge port 48 of the supercharger 42 and an air intake port 54 of the combustion engine E, an intake air chamber 52 is disposed, and the discharge port 48 of the supercharger 42 and the intake air chamber 52 are directly connected with each other. The intake air chamber 52 serves to reserve the high pressure intake air I supplied from the discharge port 48 of the supercharger 42. Between the intake air chamber 52 and the air intake port 54, a throttle body 44 is disposed.

In the throttle body 44, fuel is injected from a fuel injection valve 45 into the intake air to form a fuel mixture, and this fuel mixture is in turn supplied from each intake air port 47 to the combustion chamber 71 (shown in FIG. 3) within a cylinder bore 69 of the combustion engine. The intake air chamber 52 referred to above is disposed above the supercharger 42 and the throttle body 44. Above the intake air chamber 52 and the throttle body 44, the fuel tank 15 referred to above is disposed.

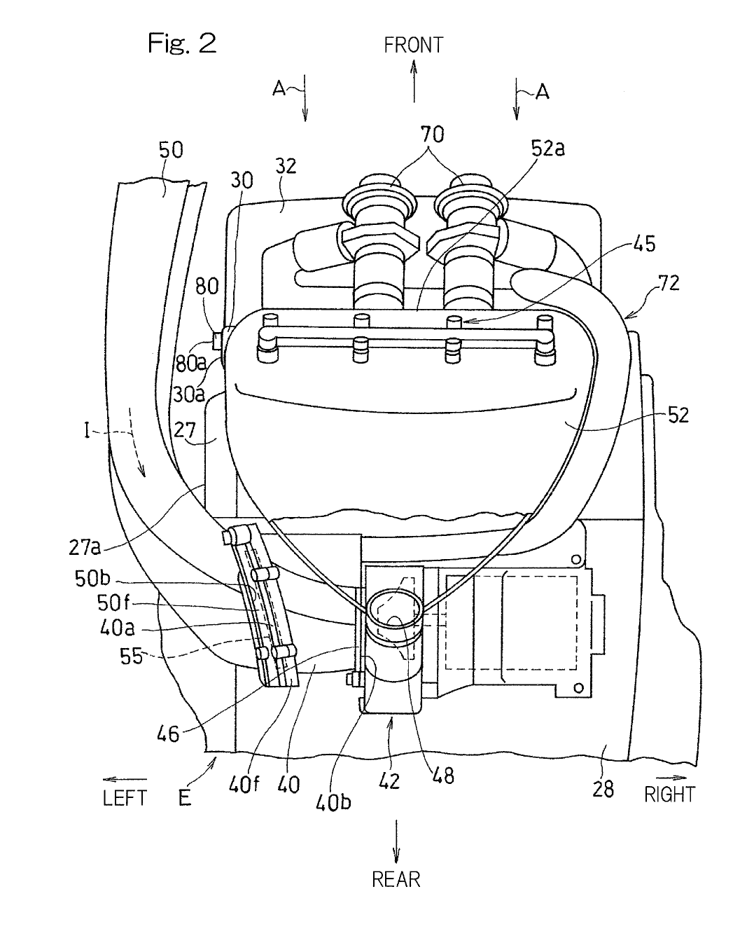

As shown in FIG. 2, the supercharger 42 is disposed adjacently on a right side of the air cleaner 40 and is fixed to an upper surface of the transmission casing portion 33 in the crankcase 28 by means of bolts. The supercharger 42 has an suction port 46 positioned upwardly of the crankcase 28 and somewhat on a left side of an intermediate portion of the combustion engine E with respect to the widthwise direction, whereas the discharge port 48 of the supercharger 42 is positioned at the intermediate portion of the engine E with respect to the vehicle widthwise direction. The suction port 46 of the supercharger 42 is opened leftwards, whereas the discharge port 48 is opened upwardly.

The air cleaner 40 has a cleaner outlet 40b fluid connected with the suction port 46 of the supercharger 42. The air intake duct 50 has a rear end portion 50b fluid connected with a cleaner inlet 40a of the air cleaner 40.

Between a flange portion 50f of the air intake duct 50 and a flange portion 40f of the air cleaner 40, an element 55 for substantially purifying the outdoor air (intake air) I is disposed. The intake air chamber 52 has a front surface 52a provided with a relief valve 70 for suppressing an undesirable increase of the internal pressure inside the intake air chamber 52. A high pressure air relieved from the relief valve 70 is introduced into a clean chamber of the air cleaner 40, positioned rearwardly of the cylinder block 30, through a relief pipe 72.

The cylinder block 30 has a left side end surface 30a where a knock sensor 80 is fitted for detecting the occurrence of knocking in the combustion engine E. The knock sensor 80 is preferably positioned at a site adjacent a bore in the cylinder block 30, particularly at a site adjacent the cylinder head 32. The knock sensor 80 is of a type capable of detecting a vibration waveform of a particular frequency transmitted from each cylinder to the cylinder block 30, and an engine control unit (not shown) determines the presence or absence of knocking in each cylinder from the waveform so detected, so that in dependence on this determination the intake air pressure, the air intake amount, the engine firing timing, the fuel injection amount and others can be adjusted.

The knock sensor 80, while in a condition as fitted to the cylinder block 30, has a portion (tip end portion) thereof protruding from the cylinder block 30 towards one of the opposite sides (for example, the left side, in the embodiment now under discussion) of the engine rotary shaft direction. A projecting end 80a of this knock sensor 30 is disposed inwardly of the vehicle widthwise direction beyond the imaginary plane passing through an outer side end edge 27a of the generator covering 27 and extending in the forward and rearward or longitudinal direction. As shown in FIG. 1, the air intake duct 50 passes laterally outwardly of the knock sensor 80. Accordingly, the knock sensor 80 is concealed by the air intake duct 50 and the knock sensor 80 is, accordingly, not viewable from lateral side.

FIG. 3 is a diagram showing the combustion engine E as viewed in a bore axial line X1 direction (diagonally upwardly and forwardly) of the cylinder. FIG. 3 illustrates the engine E with the cylinder head removed. At a site rearwardly of the cylinder block 30, a starter motor 82 is disposed on a portion of the upper surface of the crankcase 28 and forwardly of the supercharger 42. A balancer gear (not shown) id disposed on a left side of the starter motor 82 and is covered from above by a balancer covering 84 fixed to the crankcase 28 and the cylinder block 30 by means of bolts. Above the starter motor 82, a blow-by gas removing opening 86, which is oriented rearwards, is formed in a rear surface of the cylinder block 30 and is connected with a cleaning chamber of the air cleaner 40 (best shown in FIG. 2).

Between the balancer gear covering 84 and the blow-by gas removing opening 86, a coolant water intake opening 88 is formed on a rear surface of the cylinder block 30. A cooling water drawn from the coolant water intake opening 88 flows through a water jacket (cooling passage) 90 formed within the interior of a wall of the cylinder block 30 and the cylinder head 32 to cool various parts of the combustion engine E.

Also, the cylinder block 30 is formed with a plurality of, for example, 10, bolt holes 96 that extend in the bore axial line X1 direction. A bolt, having extended through the cylinder head 32 shown in FIG. 1, is inserted in each of those bolt holes 96 and is then threaded into the crankcase 28. Accordingly, the cylinder block 30 and the cylinder head 32 are connected with the crankcase 28. Moreover, a knock pin 99 is disposed on an outer side of each of the bolt holes 96.

A cam chain 100, which is a power transmission mechanism for transmitting the rotational force of the combustion engine E to a cam shaft (not shown), is provided on a right side of the cylinder block 30. This cam chain 100 is disposed within a chain tunnel 102 defined in a wall of the cylinder block 30. The knock sensor 80 referred to previously is fitted to a left side end surface 30a on the opposite side of the cam chain 100.

The knock sensor 80 is recommended to be disposed in the vicinity of the cylinder where the knocking is apt to occur. In the practice of the embodiment now under discussion, the knock sensor 80 is disposed in the vicinity of a first cylinder CY1 on the left side, which is ignited at the earliest timing in one cycle of the four cylinder combustion engine. The firing sequence is the first cylinder CY1, followed by the second cylinder CY2, followed by the fourth cylinder CY4 and finally followed by the third cylinder CY3.

The cylinder, where the knocking is apt to occur, is one of the cylinder that is ignited in advance of the neighboring cylinder. In the practice of the embodiment now under discussion, the first cylinder CY1 is ignited earlier than the neighboring second cylinder CY2, and the fourth cylinder CY4 is ignited earlier than the neighboring third cylinder CY3. In contrast thereto, the second cylinder CY2 is ignited after the ignition of the neighboring first cylinder CY1 and the third cylinder CY3 is ignited after the ignition of the neighboring fourth cylinder CY4. Since the cylinder that is ignited earlier than the next adjacent cylinder can guide a substantial amount of the high pressure intake air to the cylinder as compared with the cylinder that is ignited after the ignition of the neighboring cylinder, and therefore, a high output results in. With the knock sensor 80 disposed in the vicinity of the cylinder that results in the high output as discussed above, the occurrence of the knocking can be effectively detected.

Where the output of each cylinder varies depending on, for example, the firing sequence, the ignition timing, the compression ratio, the shape of the intake air passage, the shape of the exhaust passage, the air-fuel mixing ratio, the intake air amount, the fuel supply amount and differences in characteristic of intake and exhaust valves, it is better to dispose the knock sensor 80 in the vicinity of the cylinder that results in the high output, rather than the low output. Also, the firing sequence may be changed so that, for example, the cylinder closer in position to the knock sensor 80 gives rise to a higher output than any other cylinders. Arrangement may be so made that by setting the ignition timing, the compression ratio, the shape of the passage, the air-fuel mixing ratio and others, besides the firing sequence, output of the cylinder closer in position to the knock sensor 80 can result in the higher output than that of any other neighboring cylinders.

Also, the knock sensor 80 is extended in the longitudinal direction and is then disposed in the vicinity of a main harness 98 that is used to electrically connect a fuel injection device, gauges and others with a control unit. Accordingly, a short lead 80b is sufficient to connect the knock sensor 80 with the main harness 98 and, therefore, the wiring can be easily accomplished.

Relative to a orthogonal direction (longitudinal direction) X3 perpendicular to both of the bore axis direction X1, shown in FIG. 1, and a rotational axial direction X2 of the engine rotational shaft, the knock sensor 80 shown in FIG. 3 is disposed in an end portion of the left side end surface 30a of the cylinder block 30 in the orthogonal direction X3, specifically in a rear end portion of the left side end surface 30a. In other words, the knock sensor 80 is disposed at a site proximate to an outer surface (rear surface) of the cylinder head 32 of the cylinder structural body, where the air intake port 54 is disposed, and at a portion (rear portion) proximate to the transmission casing 33. Also, the knock sensor 80 is disposed on a rear side of the bolt hole 96 and the water jacket 90 formed inside the wall of the cylinder block 30.

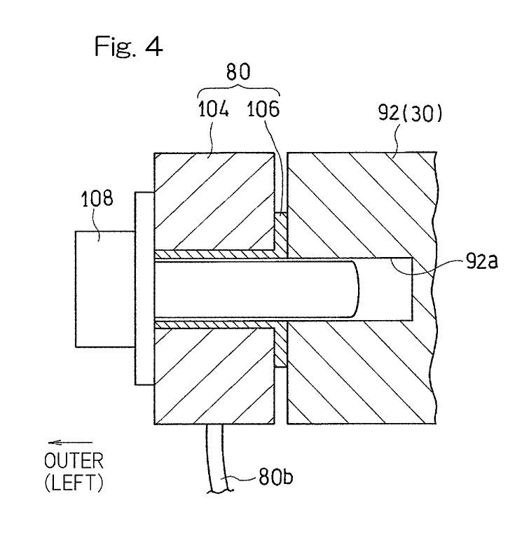

More specifically, a boss portion 92 extending laterally outwardly (in the leftward direction) is formed in a rear end portion of the left side end surface 30a of the cylinder block 30, and the knock sensor 80 is fitted to this boss portion 92. As shown in FIG. 4, the knock sensor 80 includes a disc shaped sensor main body 104 and a one-side flanged collar 106 integrally inserted into a hollow of the disc shaped sensor main body 104, which collar 106 has a barrel portion 106a made of a metallic material and a collar portion 106b formed in the barrel portion 106a.

In a condition in which an end face of the collar portion 106b of the flanged collar 106 is held in contact with a left side end face of the boss portion 92, after a flanged bolt 108 has been inserted from outside into the interior of the collar 106, the flanged bolt 108 is threaded into a threaded hole 92a, formed in the boss portion 92. By so doing, the knock sensor 80 is supported by the cylinder block 30.

In the construction hereinbefore fully described, as shown in FIG. 3, peripheral components such as, for example, the coolant water intake opening 88, the balancer, the starter motor 82, the blow-by gas removal opening 86 and so on are disposed in the rear portion of the cylinder block 30. However, since the knock sensor 80 is fitted to the left side end surface 30a of the cylinder block 30 , the space around the combustion engine can be efficiently utilized without permitting the knock sensor 80 to interfere with the peripheral components positioned rearwardly of the cylinder block 30. As a result, the assemblability and the maintenance capability of the knock sensor 80 are increased.

Also, the knock sensor 80 is disposed in the rear end portion of the left side end surface 30a of the cylinder block 30. Accordingly, vibrations of the cylinders CY2 to CY4 that are separated from the knock sensor 80 through walls of the cylinder block 30, which extend in the rotational axial direction X2 and the orthogonal direction (longitudinal direction) X3, can also be detected.

In addition, the knock sensor 80 is disposed on a rear side of the water jacket 90 and the bolt hole 96. Accordingly, the vibrations from the cylinders CY1 to CY4 are transmitted directly to the knock sensor 80, bypassing the water jacket 90 and the bolt hole 96, and, therefore, the knocking can be precisely detected.

Also, the knock sensor 80 is disposed in the vicinity of a site proximate to an outer surface (rear surface) of the left side end surface 30a of the cylinder block 30, where the air intake port 54 (shown in FIG. 1) is disposed. Since the air intake side is lower in temperature than the exhaust side, temperature increase of the knock sensor 80 is suppressed.

Furthermore, the knock sensor 80 is fitted to the left side end surface 30a of the cylinder block 30 which is on the side opposite to the cam chain 100. Accordingly, the space around the combustion engine E can be efficiently utilized without allowing the cam chain 100 and the knock sensor 80 to interfere with each other. Also, since the knock sensor 80 is disposed on the left side where a side stand 29 is disposed, even when no air intake duct 50 exist, the knock sensor 80 and the lead line 80b are hard to observe when the motorcycle is self-supported with the use of the side stand 29.

Also, the knock sensor 80 is disposed inwardly of the outer side end edge 27a of the generator covering 27 with respect to the vehicle widthwise direction. Accordingly, even when the motorcycle falls down laterally, the knock sensor 80 can be prevented by the generator covering 27 from being impaired.

Further, since the knock sensor 80 is disposed in the vicinity of the first cylinder that is ignited at the earliest timing during the one cycle, the occurrence of the knocking can be effectively detected. In addition, regarding the cylinders distant from the knock sensor 80, vibrations are transmitted to the knock sensor 80 through a rear wall 30b of the cylinder block 30 and, therefore, the use of the only one knock sensor 80 is sufficient to detect the occurrence of knocking in any of the cylinders.

Also, the knock sensor 80 is disposed in the rear portion of the left side end surface 30a of the cylinder block 30, which is a site proximate to the transmission casing 33 (rear portion of the crankcase 28), and the supercharger 42 is disposed above the transmission casing 33. Accordingly, the space around the engine E can be further efficiently utilized.

The knock sensor 80 is preferably disposed on the orthogonal direction outer side (rear side, according to the illustrated embodiment) of the bore of the cylinder. Also, the knock sensor 80 is preferably disposed in the orthogonal direction outside (rear side, according to the illustrated embodiment) of the water jacket 90. Further, the knock sensor 80 is preferably disposed on the rotational axial direction outer side (rear side, according to the illustrated embodiment) of the bolt hole 96 and/or in the orthogonal direction outer side (left side, according to the illustrated embodiment) of the bolt hole 96. Accordingly, detection of the vibration taking place in the cylinder at the position distant from the knock sensor 80 can be facilitated.

The present invention is particularly applicable to the combustion engine having the supercharger mounted thereon, which is apt to be knocked. The supercharger may driven by, beside the rotational force of the crankshaft, the exhaust energies, the electric motor and others. In the case of the multi-cylinder combustion engine, the number of the knock sensors can be reduced and the manufacturing cost can be suppressed. In particular, the present invention can be suitably applied to the combustion engine of a type in which a plurality of the cylinders are juxtaposed in the rotational axial direction.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. By way of example, although in describing the preferred embodiment, the knock sensor 80 has been shown and described as fitted to the cylinder block 30 shown in FIG. 1, but the knock sensor 80 may be fitted to the cylinder head 32. Where the knock sensor 80 is to be fitted to the cylinder block 30, positioning of the knock sensor 80 at an upper portion proximate to the combustion chamber 71 (shown in FIG. 3) is preferred. On the other hand, where the knock sensor 80 is to be fitted to the cylinder head 32, positioning of the knock sensor 80 at a lower portion proximate to the combustion chamber 71 (shown in FIG. 3) is preferred.

Also, although in describing the preferred embodiment the only one knock sensor 80 has been shown and described at the left side end surface 30a of the cylinder block 30, an auxiliary knock sensor may be additionally employed together with the knock sensor 80 so that by means of both of the knock sensors, the occurrence of knocking can be further accurately detected. In such case, the auxiliary knock sensor may be disposed at any arbitrarily chosen position, but positioning of it at a right side portion distant from the main knock sensor 80 is particularly preferred.

By way of example, although in describing the preferred embodiment set forth above, reference has been made to the four cylinder four cycle engine having the supercharger mounted thereon, the present invention is not necessarily limited thereto and can be equally applied to a two cylinder engine or a single cylinder engine with or without the supercharger mounted thereon. The present invention is also applicable to an engine for any vehicle other than the motorcycle, a marine engine or the like or any ground installed engine.

Accordingly, such changes and modifications are, unless they depart from the scope of the present invention as delivered from the claims annexed hereto, to be construed as included therein.

### REFERENCE NUMERALS

26 . . . Crankshaft (Rotary shaft)
27 . . . Covering (Generator covering)
28 . . . Crankcase
30 . . . Cylinder block (Cylinder structural body)
32 . . . Cylinder head (Cylinder structural body)
33 . . . Transmission casing
42 . . . Supercharger
54 . . . Air intake port
71 . . . Combustion chamber
80 . . . Knock sensor
90 . . . Water jacket (Cooling passage)
96 . . . Bolt hole (Hole)
100 . . . Cam chain (Power transmission mechanism)
E . . . Engine
X1 . . . Bore axial line
X2 . . . Rotational axial direction
X3 . . . Orthogonal direction

What is claimed is:

1. An engine comprising:
a cylinder structural body configured to define a combustion chamber of an internal combustion engine; and
a knock sensor configured to detect the occurrence of a knocking in the engine, the knock sensor being fitted to one side end surface of the cylinder structural body in a rotational axial direction of a rotary shaft of the engine.

2. The engine as claimed in claim 1, in which the knock sensor is disposed in one end of the cylinder structural body in an orthogonal direction perpendicular to both of the rotational axial direction of the rotary shaft and a direction of a bore axial line.

3. The engine as claimed in claim 2, in which the knock sensor is disposed on an outer side of the orthogonal direction opposite to a cooling passage which is formed in an interior of a wall of the cylinder structural body.

4. The engine as claimed in claim 2, wherein
the cylinder structural body has a mounting hole defined therein so as to extend in the direction of the bore axial line, and
the knock sensor is disposed on an outer side of the orthogonal direction opposite to the hole.

5. The engine as claimed in claim 1, in which the knock sensor is disposed at a portion proximate to an outer surface, of the cylinder structural body, where an air intake port is disposed.

6. The engine as claimed in claim 1, in which the knock sensor is disposed in a side end surface of the cylinder structural body that is on an opposite side of a power transmission mechanism configured to transmit a rotational force of the engine to a camshaft.

7. The engine as claimed in claim 1, in which the knock sensor is disposed on an inner side of the rotational axial direction opposite to an outer side end edge of a covering mounted on one side portion of the engine.

8. The engine as claimed in claim 1, wherein
the engine is in the form of a multi-cylinder engine; and
the knock sensor is disposed in the vicinity of one of cylinders that is apt to be knocked.

9. The engine as claimed in claim 8, wherein the cylinder that is apt to be knocked has a high output power as compared with any other cylinder.

10. The engine as claimed in claim 1, wherein
a crankcase is formed with a transmission casing, and
the knock sensor is disposed in a portion of a side end surface of the cylinder structural body, which portion is close to the transmission casing side.

11. The engine as claimed in claim 10, in which a supercharger configured to compress an air and then supply the air to the engine is disposed above the transmission casing.

12. The engine as claimed in claim 1, wherein:
the engine is in the form of a multi-cylinder engine; and
the knock sensor is disposed in one end of the cylinder structural body in an orthogonal direction perpendicular to both of the rotational axial direction of the rotary shaft and a direction of a bore axial line.

13. The engine as claimed in claim 1, wherein:
the engine comprises a crankcase configured to support the rotary shaft, a cylinder block protruding from the crankcase in a bore axial line, and a cylinder head protruding from the cylinder block in the bore axial line; and
the knock sensor is disposed in a portion of a wall surface of the cylinder block, which portion forms a wall extending in the rotational axial direction, and is disposed in the vicinity of the cylinder head.

14. The engine as claimed in claim 1, wherein:
the engine comprises a crankcase configured to support the rotary shaft, a cylinder block protruding from the crankcase in a bore axial line, and a cylinder head protruding from the cylinder block in the bore axial line; and
the knock sensor is disposed in a portion of a wall surface of the cylinder head, which portion forms a wall extending in the rotational axial direction, and is disposed in the vicinity of the cylinder block.

15. The engine as claimed in claim 1, wherein:
the engine is a driving source for a motorcycle; and
the knock sensor is disposed on one side where a side stand is disposed.

16. The engine as claimed in claim 1, wherein
the engine is a driving source for a motorcycle; and
the knock sensor is disposed on one side where a main harness is disposed.

17. A multi-cylinder engine in which a plurality of cylinder are arranged in line in a rotational axial direction of a rotary shaft, the engine comprising:
a crankcase configured to support the rotary shaft;
a cylinder block configured to protrude from the crankcase in a bore axial line, the cylinder block defining a combustion chamber of the engine; and
a knock sensor configured to detect the occurrence of a knocking in the engine, the knock sensor being fitted to one side end surface of the cylinder block in the rotational axial direction, wherein
the knock sensor is disposed in one end portion of the cylinder block in a direction of a bore axial line, which portion is far away from the crankcase, and in one end portion of the cylinder block in an orthogonal direction perpendicular to both of the rotational axial direction and the direction of the bore axial line.
